(19) United States
(12) Patent Application Publication
(10) Pub. No.: US 2011/0231007 A1
(43) Pub. Date: Sep. 22, 2011

(54) AUTOMATED LIBRARY

(75) Inventors: Michael Biehle, North Vernon, IN (US); Dustin L. Maschino, North Vernon, IN (US)

(73) Assignee: BIEHLE ELECTRIC INC., Seymour, IN (US)

(21) Appl. No.: 13/052,647

(22) Filed: Mar. 21, 2011

Related U.S. Application Data
(60) Provisional application No. 61/315,702, filed on Mar. 19, 2010.

(51) Int. Cl. G06F 7/00; G06Q 90/00

(52) U.S. Cl. 700/218; 235/385; 901/14

(57) ABSTRACT

An automated library including a housing unit containing a plurality of shelves containing slots to hold digital and print media; a programmable robot contained within the housing unit; a patron interface panel including a touch screen, a library card reader, and receipt printer secured to a wall of the housing unit for entering data; and a media receipt and distribution system secured to a wall of the housing unit that determines the size and/or shape of media being received or distributed through the media receipt and distribution system and controls the ingress and egress of the media.

### CROSS-REFERENCE TO RELATED APPLICATION

This application claims priority from U.S. Provisional Application Ser. No. 61/315,702, filed on Mar. 19, 2010.

### BACKGROUND OF A PREFERRED EMBODIMENT

This invention relates to a library structure. More specifically, this invention relates to an automated library that may be easily transported and placed in a location in which access to municipal library facilities is limited or non-existent. Notwithstanding, this invention may be adapted for use to distribute items not associated with libraries. Thus, this invention is not limited to uses associated with conventional library distribution of conventional media, such as books, compact discs, DVD's, etc.

With the expansion of cities and the resulting increased number of persons living further from city centers where municipal brick and mortar libraries are located, there is an increased need for access to the digital and print media provided by municipal libraries. Further, as several municipalities currently face economic challenges and have cut their budgets of programs offering services to the public, patrons may find themselves living in areas where brick and mortar libraries are no longer in operation. Similarly, these brick and mortar libraries may be located at such a distance from the residences of patrons that accessing them is impractical.

In response to the need of greater access to the services provided by libraries, mobile libraries have been established. Mobile libraries currently in existence are often modified recreational vehicles or buses that visit underserved areas at set times throughout the year. One limitation of these existing mobile libraries is that they must be staffed, either by an operator who drives the recreational vehicle or bus exclusively or by an operator in addition to a library staff person or persons who assist in the selection, check-out, and return of library media materials. These staff persons must also be compensated for time spent re-stocking and or re-shelving items. An additional limitation arises from the need for funds to cover the additional expense of fuel to transport the vehicle from stop to stop along the scheduled route. Further, coordination of operation of such mobile libraries with brick and mortar libraries is also problematic.

For the foregoing reasons, there is a need for a portable library structure for print and digital media that can be transported to an underserved location where it can remain for an extended period of time with the need for human intervention only for periodic maintenance.

### SUMMARY OF ONE PREFERRED EMBODIMENT

In accordance with one preferred embodiment, there is provided an automated library including a housing unit containing a plurality of shelves containing slots to hold digital and print media;

a programmable robot contained within the housing unit;

a patron interface panel, including a touch screen, a library card reader, and receipt printer secured to a wall of the housing unit for entering data; and

a media receipt and distribution system incorporated into a wall of the housing unit.

In a further embodiment this media receipt and distribution system includes a system for determining the nature, size, and shape of the media being received or distributed by the automated library. In a further embodiment the media receipt and distribution system controls the ingress and egress of the media into and out of the automated library.

### BRIEF DESCRIPTION OF THE DRAWINGS

This invention is now described with reference to the accompanying drawings in which:

FIG. 1 is a top, perspective view of one preferred embodiment of the automated library;

FIG. 2 is a bottom perspective view of the automated library of FIG. 1;

FIG. 3 is a top perspective view of the automated library, as shown in FIG. 1, with ceiling panels removed, thus, showing an automated robot within the automated library;

FIG. 4 is a cut away view of a portion of a front panel of the automated library, as shown in FIG. 3;

FIG. 5 is a cut away view of a portion of the automated library shown in FIG. 3 showing a portion of the automated robot in use within the automated library;

FIG. 6 is a front view of one embodiment of a patron interface panel of the automated library, as shown in FIGS. 1, 2 and 3;

FIG. 6a is a side view of the patron interface panel of FIG. 6 showing a side view of the media receipt and distribution system;

FIG. 6b is a back view of the patron interface panel of FIG. 6 as shown from the inside of the automated library of FIGS. 1, 2 and 3;

FIG. 6c is a bottom view of the patron interface panel of FIG. 6 showing the bottom portion of a media receipt and distribution system and a library card reader;

FIG. 6d is a bottom view of FIG. 6c;

FIG. 7 is a bottom perspective view of one embodiment of the media receipt and distribution system of the automated library of FIGS. 1, 2, and 3 shown from the front;

FIG. 7a is a front view of the media receipt and distribution system of FIG. 7;

FIG. 7b is a side view of the media receipt and distribution system of FIG. 7;

FIG. 7c is a top perspective view of the media receipt and distribution system of FIG. 7 shown from the front of the system; and

FIG. 7d is a top view of the media receipt and distribution system of FIG. 7.

FIG. 8 is a top perspective exploded view of the media receipt and distribution system of FIG. 7.

FIG. 9 is a bottom perspective exploded view of the media receipt and distribution system of FIG. 7.

FIG. 10 is a side perspective view of an alternative embodiment of the media receipt and distribution system of the automated library, as shown in FIGS. 1, 2, and 3.

FIG. 10a is a side perpective view of an alternative embodiment of the media receipt and distribution system of FIG. 10.

FIG. 10b is a rear view of an alternative embodiment of the media receipt and distribution system of FIG. 10.

FIG. 11 is an exploded rear perspective view of an alternative embodiment of the media receipt and distribution system of FIG. 10.

FIG. 12 is an exploded front perspective view of an alternative embodiment of the media receipt and distribution system of FIG. 10.

FIG. 13 is a perspective view of the electric gripper and gripper fingers.

FIG. 13a is a rear view of the electric gripper and gripper fingers.

FIG. 13b is a top view of the electric gripper and gripper fingers.

FIG. 13c is a side view of the electric gripper and gripper fingers.

FIG. 13d is a top view of the electric gripper and gripper fingers.

FIG. 14 is an upper exploded perspective view of the electric gripper and gripper fingers.

FIG. 15 is an upper exploded perspective view of the electric gripper and gripper fingers rotated 90°.

### DETAILED DESCRIPTION OF ONE EMBODIMENT

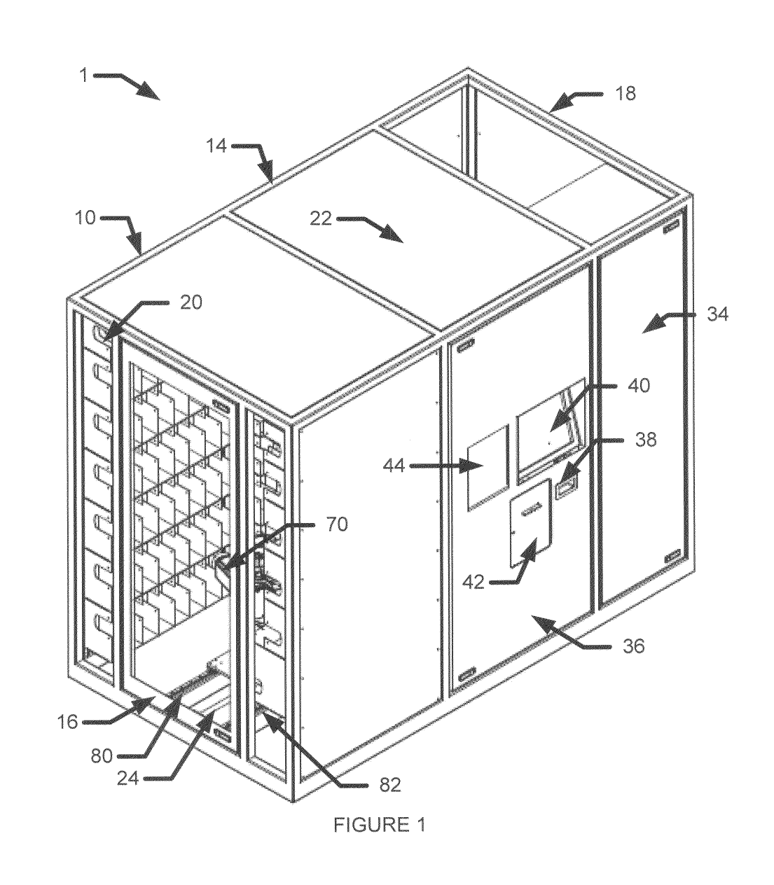

Although the automated library is adaptable to a wide variety of structures and uses, it is shown in the drawings and described in this detailed description in one preferred embodiment as an automated library (1), particularly for use in indoor public or private buildings, as shown in FIGS. 1, 2, and 3, particularly for use with public library systems. Notwithstanding the embodiments disclosed herein, the disclosures are not limited to the distribution of media for libraries, but may be adapted to use for the distribution of a number of different types of products and different distributions. In one embodiment, this automated library (1) includes but is not limited to: a housing unit (10) including an automated robot (70); a patron interface panel (36) containing a library card reader (38), a touch screen (40), a receipt printer (42); and a media receipt and distribution system (44).

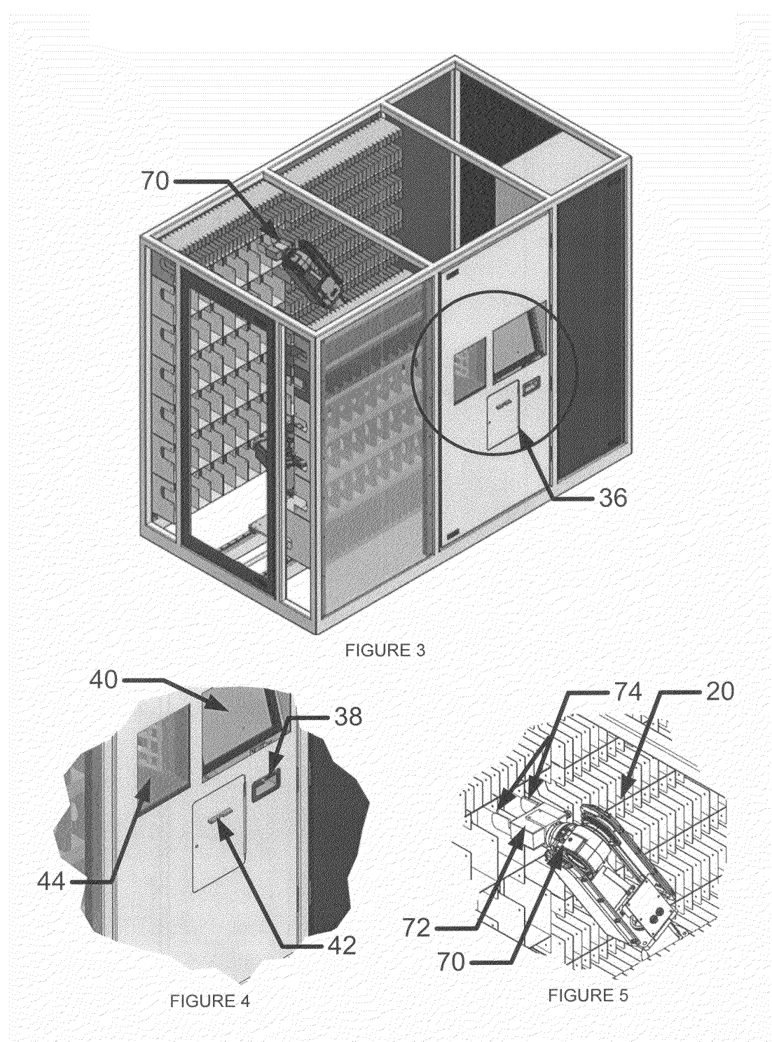

The housing unit (10), as shown in FIGS. 1, 2, and 3, includes a front wall (12), rear wall (14), side walls (16, 18), shelving (20), ceiling (22), and floor (24). The housing unit (10) of one preferred embodiment is, but is not limited to, a cubical shape, with other shapes being included. The walls (12, 14, 16, 18) of the structure may be constructed of glass, metal, or other structural materials, preferably steel. It is preferred that glass be incorporated into some or all of the walls (12, 14, 16, 18) of the housing unit (10) as a glass wall enables patrons to view the media items available on the shelving (20) within the housing unit (10). The shelving (20) is secured to an interior of the walls (12, 14, 16, 18) of the housing unit (10), as shown in FIGS. 1 and 3, by conventional securing system and includes slots of various sizes to accommodate the variable sizes of media items, such as compact discs, digital versatile discs, children's books, periodicals, and other books. The shelving (20) can be constructed of any conventional materials, but is preferably constructed of stainless steel. To accommodate the glass walls of the housing unit (10), the ends of the slots in the shelving (20) may be open towards those walls so patrons can view the media present in the slots of the shelving (20). Also incorporated into the walls (12, 14, 16, 18) of the housing unit (10) are conventional electrical outlets to provide power to the automated library (1) and other conventional components of this type of structure.

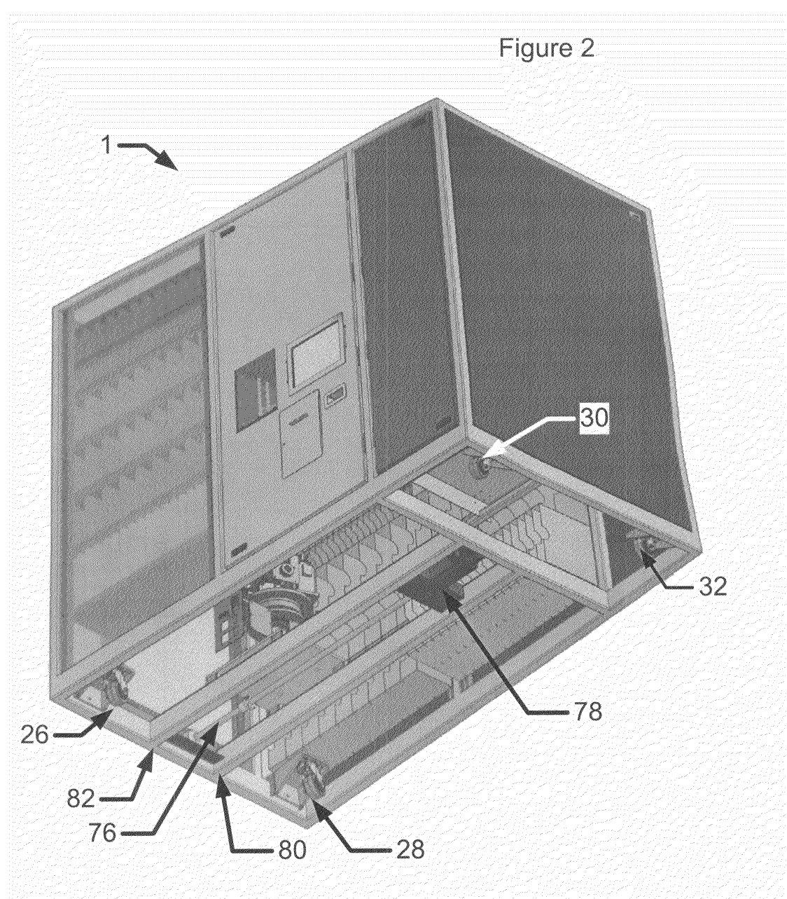

As illustrated in FIG. 2, affixed to the exterior of the floor (24) of the housing unit (10) of one preferred embodiment are systems for the mobility of the automated library such as four caster assemblies with wheels (26, 28, 30, 32) that provide for ease in transport of the automated library (1). As illustrated in FIG. 1, a controller access door (34) is incorporated into the front wall (12) of the housing unit (10) allowing for access to the interior of the housing unit (10) for repair and maintenance. Other than the controller access door (34) which permits access for service, the automated library (1) is preferably a closed, self-contained system.

As illustrated in FIGS. 1, 3, and 4, also incorporated into the front wall (12) of the housing unit (10) is a patron interface panel (36) including a library card reader (38), touch screen (40), receipt printer (42), and media receipt and distribution system (44). Other automated systems may be incorporated, such as an outlet for credit and debit cards and for receipt of money.

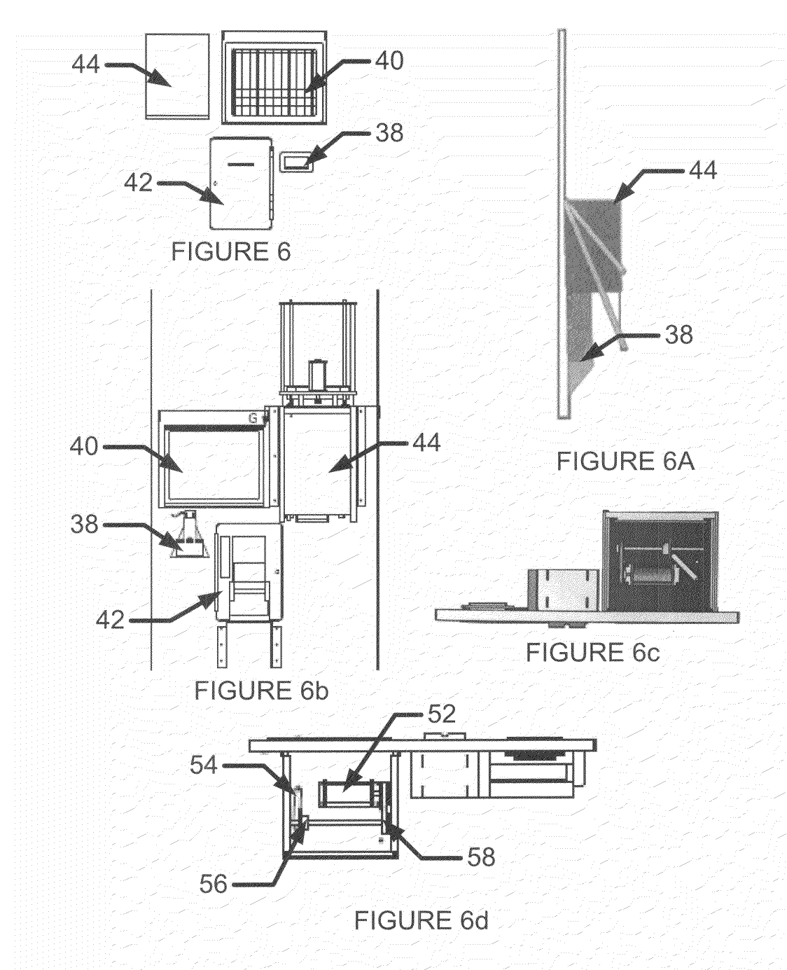

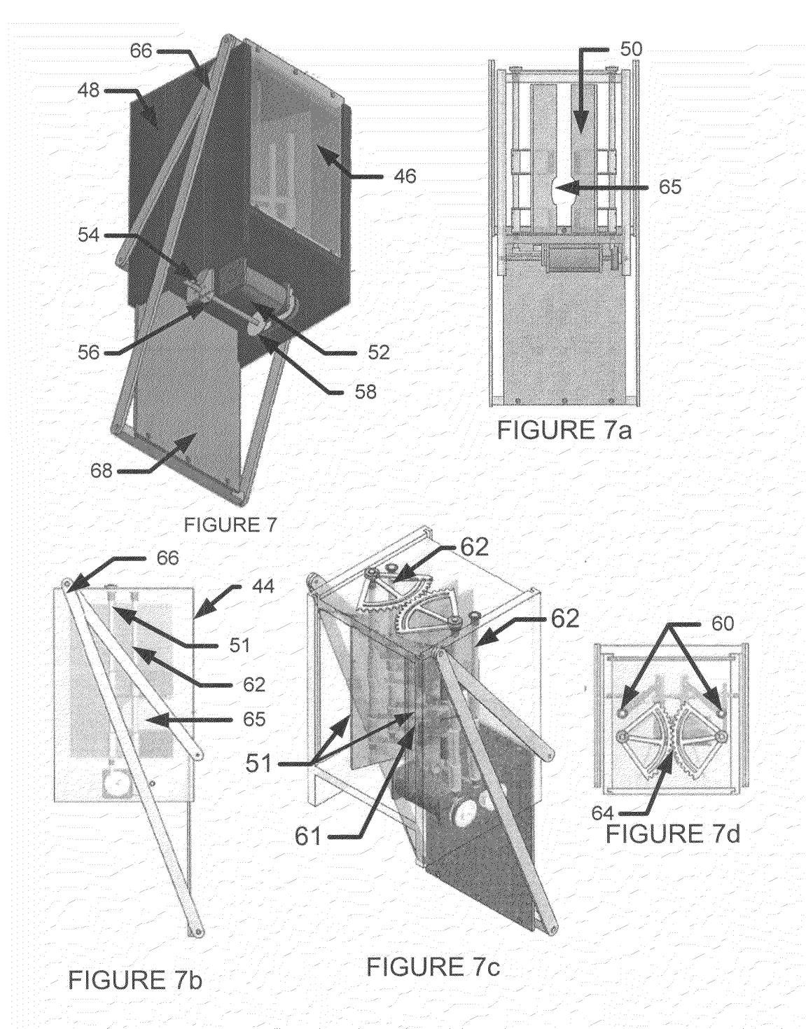

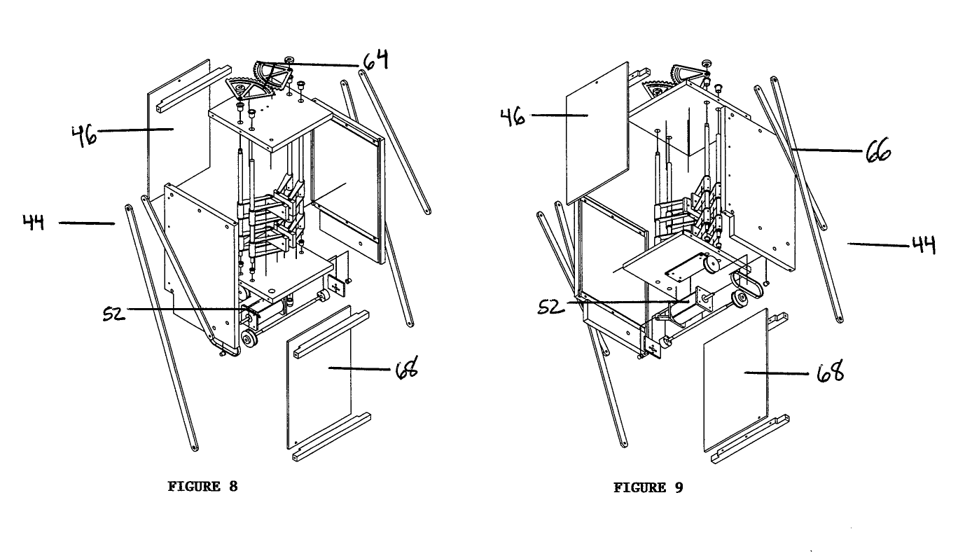

As illustrated in FIGS. 3, 4, and 6, in operation, the patron makes a selection using the touch screen (40) whether to retrieve media from or deposit media to the automated library (1). The library card reader (38) of the patron interface panel (36) contains a scanner for reading the library card, such as a barcode scanner. After the card is scanned, the patron's library account information is accessed. The receipt printer (42) of the patron interface panel (36) is linked to the computer system and provides the patron with a record of his transactions. As illustrated in FIGS. 1, 3, 4, 6, 6a, 6b, 6c, 6d, 7, 7a, 7b, 7c, 7d, 8, and 9, upon the patron's selection to deposit his media via the touch screen (40) of the patron interface panel (36), an external door (46) of the media receipt and distribution system (44) is unlocked, enabling the patron to manually raise the external door (46) of the media receipt and distribution system (44). The external door (46) of the media receipt and distribution system (44) is preferably constructed of PVC or a PVC-like product, though other materials can be used. The housing (48) of the media receipt and distribution system is preferably constructed of sturdy materials, such as nylon, plastic, or stainless steel, though other materials can be used. The external door (46) and an internal door (68) are linked via a door linkage (66), such that the internal door (68) closes as the external door (46) opens. The internal door (68) of the media receipt and distribution system (44) is preferably constructed of PVC or a PVC-like product, though other materials can be used. The patron then inserts the media item between centering gates (50) of the media receipt and distribution system (44) with the binding facing towards the patron. The centering gates (50) are preferably constructed of plastic and are beveled at an angle of at least 5°, preferably 5°-30°, so that they are wider at the portion facing the patron than the portion facing the inside of the housing unit (10). See FIG. 7a. The depth of the initial portion of the gates, before the angle, is preferably at least 30%, of the overall depth of the gate. In another embodiment, it is from 30-70% of the overall depth of the gate. The centering gates (50) are subject to constant tension on both sides, and timing gears (64) located on a top exterior surface of the media receipt and distribution system (44) connected to centering gate shafts (51) ensure that the centering gates (50) move an equal distance in coordination with each other. There are preferably two gate pivot shafts (62) affixed to the media receipt and distribution system via bushings (60) for the gate pivot shafts (62) located on the top exterior surface of the media receipt and distribution system (44). The gate pivot shafts (62) and the centering gate shafts (51) each contain two pairs of radius guide bars (63) that are secured to the centering gates (50) in order to keep the centering gates (50) consistently oriented at all times. The radius guide bars (63) may be secured directly to the outer surface of the centering gates (50) or may be secured to a fixed securing element (61) as shown in FIGS. 7 and 7c. A bar code reader and a photo sensor located within the media receipt and distribution system (44), preferably secured near the base of the media receipt and distribution system (44), confirms that the media item is in the correct position in the centering gates (50).

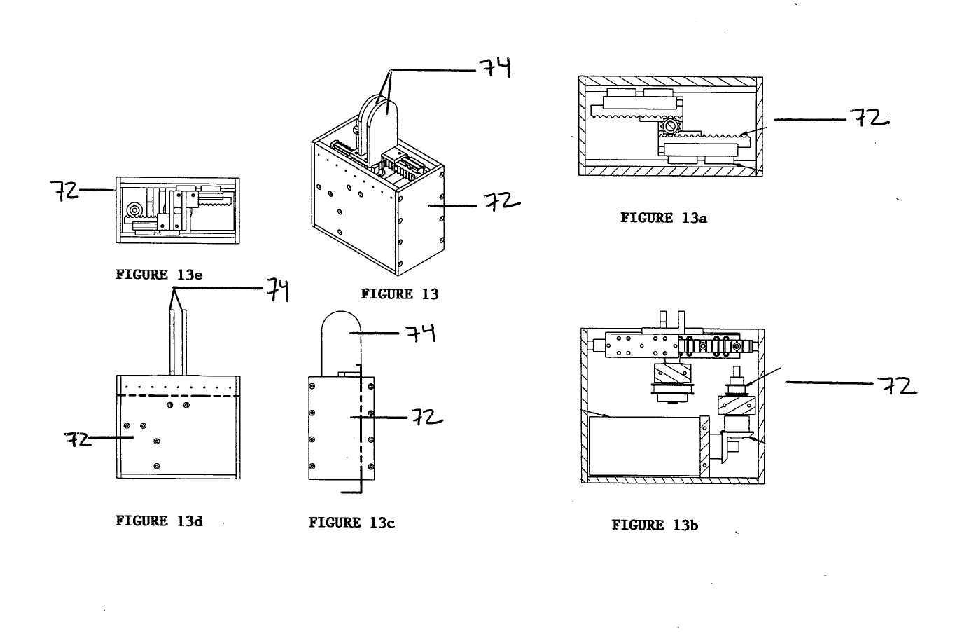

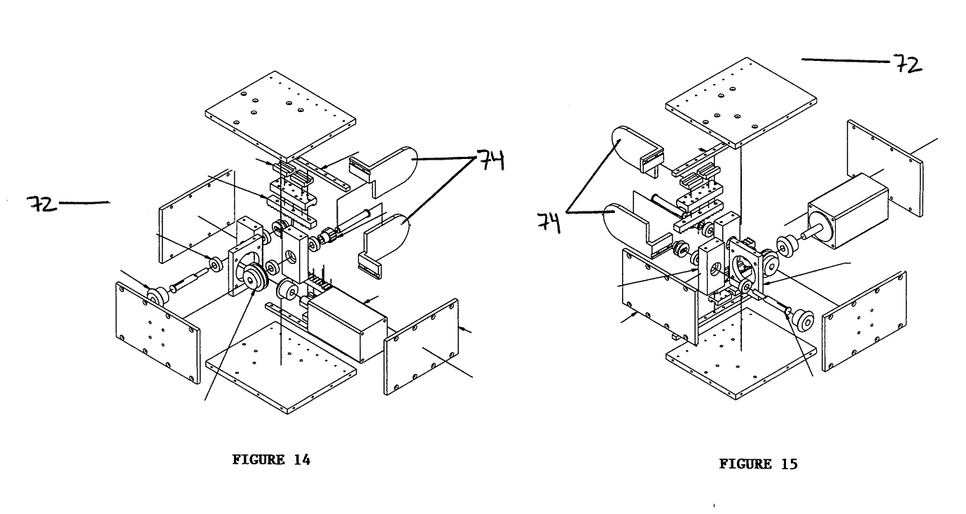

As illustrated in FIGS. 3, 4, 5, 6, 6a, 6b, 6c, 6d, 7, 7a, 7b, 7c, 7d, 8, and 9, the patron then closes the external door (46) which opens the internal door (68) via the door linkage (66). The automated robot (70) is then activated. If the position in the centering gates (50) is correct, a signal is sent to the automated robot (70) to grip the media item via an electric gripper (72) and gripper fingers (74) of the automated robot (70) which provide a means for moving the gripper fingers (74) transversely. One means for moving the gripper fingers transversely to grip media items is shown in FIGS. 13, 13a, 13b, 13c, 13d, 13e, 14, and 15. The electric gripper (72) and gripper fingers (74) of the automated robot (70) are inserted between the centering gates (50) and through a gap (65) that is formed between the centering gates (50) when closed that is wide enough to accommodate the electric gripper (72) and gripper fingers (74). (See FIGS. 7a and 7b) Once the proper torque signal is reached on the electric gripper (72), a signal is sent to a programmable logic controller. A computer interfaces with the programmable logic controller and the robot controller. A DC motor (52) of the media receipt and distribution system (44) then supplies power to the screw and nut system (56) to push the centering gate lever (54) via timing pulleys and a belt (58). The centering gates (50) then open and the media item is released for the automated robot (70) to remove it from the media receipt and distribution system (44) and to place it in an available slot in the shelving (20) of the housing unit (10).

Software in the computer maintains a record of the size and title of each media item. In one embodiment, the slots in the shelving (20) of the housing unit (10) are not dedicated. Rather, the software communicates the location of an available slot that will accommodate the media item to the automated robot (70). The automated robot (70) then pivots and inserts the media item into the available slot so that the binding is inserted first to the exterior of the housing unit (10) with the open pages facing toward the automated robot (70). The identification of the media item and its new location are then saved to the computer. By facing the binding outward, identification of the media item can be made by patrons outside of the automated library (1). (See FIGS. 1, 3, and 5).

To reverse the operation of the system, as illustrated in FIGS. 1, 3, 4, 5, 6, 6a, 6b, 6c, 6d, 7, 7a, 7b, 7c, 7d, 8, and 9, upon the patron's selection for retrieval of a media item and the subsequent selection of a particular media item via the touch screen (40) of the patron interface panel (36), the automated robot (70) is activated. The robot controller interfaces with a computer. The radio frequency identification scanner incorporated into the automated robot (70) communicates with the computer and the computer in turn communicates with the automated robot (70) which enables the automated robot (70) to locate the selected item via the radio frequency identification scanner and photo eye incorporated into the automated robot (70). The automated robot (70) moves along two linear rails (80, 82) that are affixed to the floor (24) of the housing unit (10) to locate the proper slot in the shelving (20) of the housing unit (10). A servo-motor with brake (78) supplies power to a ball screw (76) which is connected to the automated robot (70). Upon proper identification of the selected media item, a signal is sent to the automated robot (70) to grip the media item via the electric gripper (72) and gripper fingers (74) of the automated robot (70) which provide means for moving the gripper fingers (74) transversely to obtain the item from its slot. (See FIGS. 13, 13a, 13b, 13c, 13d, 13e, 14, and 15. Once the proper torque signal reaches the electric gripper (72), a signal is sent to a programmable logic controller. A computer interfaces with a programmable logic controller and the robot controller. The DC motor (52) of the media receipt and distribution system (44) then supplies power to the screw and nut system (56) to open the centering gate lever (54) via timing pulleys and a belt (58). The centering gates (50) then open and the automated robot (70) places the item within the centering gates (50). The automated robot (70) is then de-activated and the external door (46) of the media receipt and distribution system (44) is unlocked. The patron is then notified via the touch screen (40) of the patron interface panel (36) that they may manually open the external door (46) of the media receipt and distribution system (44) and remove the selected media item.

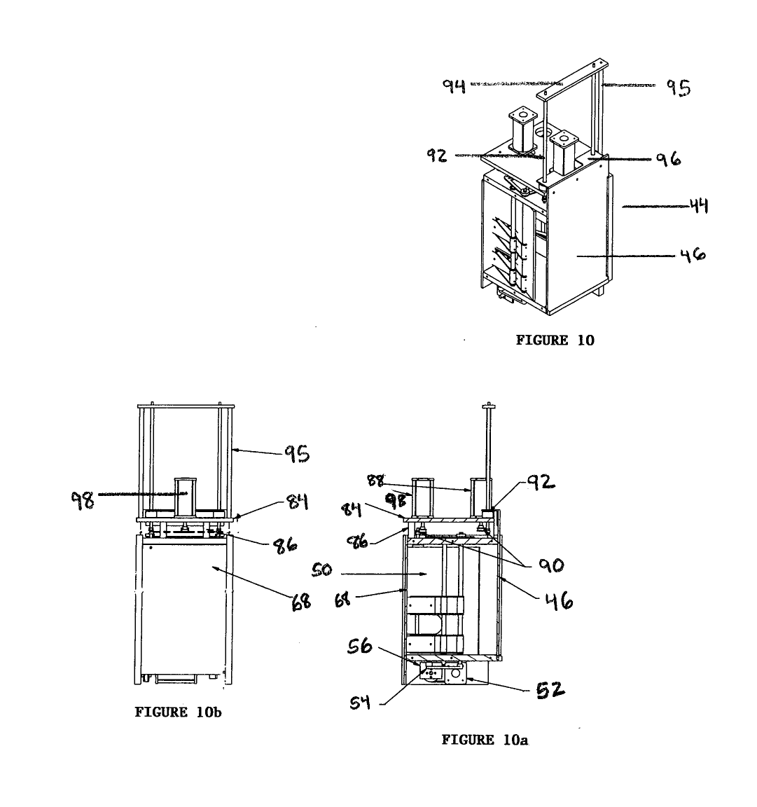

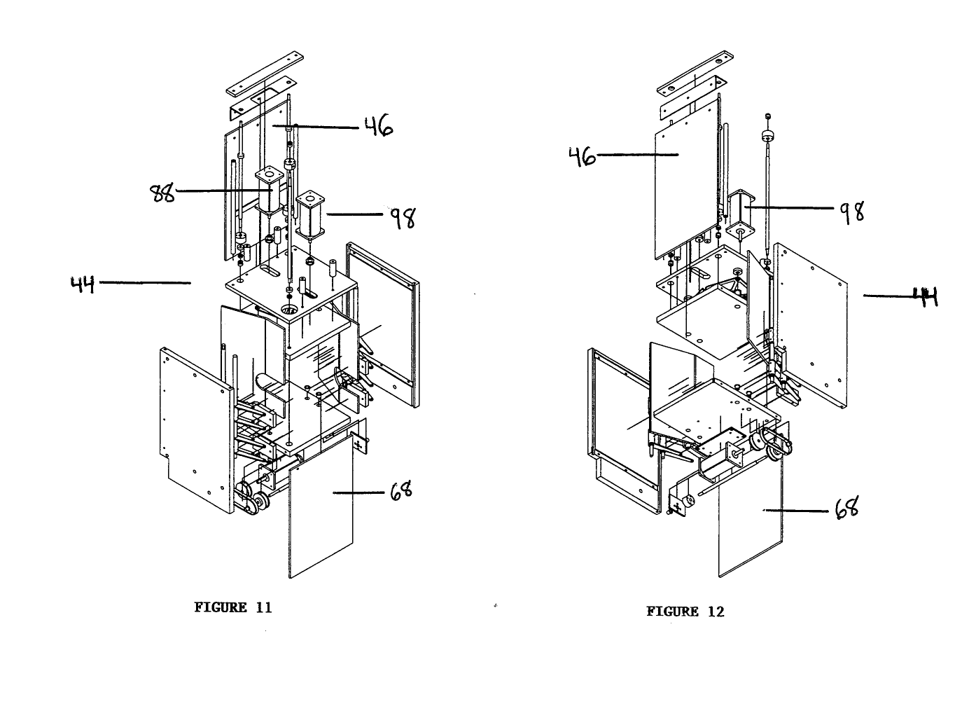

In one alternative embodiment, as illustrated in FIGS. 10, 10a, 10b, 11 and 12, the external door (46) and the internal door (68) of the media receipt and distribution system (44) are not connected via a door linkage (66). In this alternative embodiment, a motor plate (84) rests atop four motor plate risers (86) located at the four corners of the top exterior surface of the media receipt and distribution system (44). This elevated motor plate prevents interference with the operation of the timing gears (64) located on the top exterior surface of the media receipt and distribution system (44) that control the movement of the centering gates (50).

In operation of this alternative embodiment and in the embodiment previously discussed, as illustrated in FIGS. 3, 4, and 6, in operation, the patron makes a selection using the touch screen (40) whether to retrieve media from or to deposit media to the automated library (1). The library card reader (38) of the patron interface panel (36) contains a scanner for reading the library card, such as a barcode scanner. After the card is scanned, the patron's library account information is accessed. The receipt printer (42) of the patron interface panel (36) is linked to the computer system and provides the patron with a record of his transactions.

As illustrated in FIGS. 3, 4, 10, 10a, 10b, 11 and 12, upon the patron's selection to deposit his media via the touch screen (40) of the patron interface panel (36), the external door DC motor (88) supplies power to the two external door Acme screw and nut systems (92) via the external door timing pulleys and belt (90), and the external door (46) of the media receipt and distribution system (44) opens. The external door Acme screw and nut systems are inserted into an external door Acme screw upper bracket (94) along with two external door Acme screw support rods (95). The external door Acme screw and nut systems (92) are further inserted into an external door Acme screw lower bracket (96) which is further affixed to the external door (46) which enables the upward movement of the external door (46) upon rotation of the external door Acme screw and nut systems (92). The internal door (68) remains closed as the external door (46) opens. The patron then inserts the media item between centering gates (50) of the media receipt and distribution system (44) with the binding facing towards the patron.

In this alternative embodiment, as in the embodiment previously discussed, and illustrated in FIGS. 1, 10, 10a, 10b, 11, and 12, the centering gates (50) are preferably constructed of plastic and are beveled at an angle of at least 5°, preferably 5°-30°, so that they are wider at the portion facing the patron than the portion facing the inside of the housing unit (10). The depth of the initial portion of the gates, before the angle, is preferably at least 30% of the overall depth of the gate. In another embodiment, it is from 30-70% of the overall depth of the gate. The centering gates (50) are subject to constant tension on both sides, and timing gears (64) located on a top exterior surface of the media receipt and distribution system (44) connected to centering gate shafts (51) ensure that the centering gates (50) move an equal distance in coordination with each other. There are preferably two gate pivot shafts (62) affixed to the media receipt and distribution system via bushings (60) for the gate pivot shafts (62) located on the top exterior surface of the media receipt and distribution system (44). The gate pivot shafts (62) and the centering gate shafts (51) each contain two pairs of radius guide bars (63) that are secured to the centering gates (50) in order to keep the centering gates (50) consistently oriented at all times. The radius guide bars (63) may be secured directly to the outer surface of the centering gates (50) or may be secured to a fixed securing element (61) as shown in FIGS. 8 and 8a. A bar code reader and a photo sensor located within the media receipt and distribution system (44), preferably secured near the base of the media receipt and distribution system (44), confirms that the media item is in the correct position in the centering gates (50).

As shown in FIGS. 10, 10a, 10b, 11, and 12, the external door DC motor (88) then supplies power to the two external door Acme screw and nut systems (92) via the external door timing pulleys and belt (90). The external door Acme screw and nut systems (92) are inserted into an external door Acme screw upper bracket (94) along with two external door Acme screw support rods (95). The external door Acme screw and nut systems are further inserted into an external door Acme screw lower bracket which is further affixed to the external door (46) which enables the downward movement of the external door (46) upon rotation of the external door Acme screw and nut systems (92), whereby the external door (46) closes and locks. The external door Acme screw and nut systems (92) will not force the external door (46) to close if an object is blocking the external door (46). Rather, the downward movement will stop and the external door (46) will close via gravity after the object is removed. The internal door DC motor (98) then supplies power to the two internal door Acme screw and nut systems (102) via the internal door timing pulleys and belt (100). The internal door Acme screw and nut systems (102) are inserted into an internal door Acme screw upper bracket (104). The internal door Acme screw and nut systems (102) are further inserted into an internal door Acme screw lower bracket (106) which is further affixed to the internal door (68) which enables the upward movement of the internal door (68) upon rotation of the internal door Acme screw and nut systems (102), whereby the internal door (68) of the media receipt and distribution system (44) opens.

In this alternative embodiment, as in the embodiment previously discussed, the automated robot (70) is then activated. If the position in the centering gates (50) is correct, a signal is sent to the automated robot (70) to grip the media item via an electric gripper (72) and gripper fingers (74) of the automated robot (70) which provide means for moving the gripper transversely. (See FIGS. 5, 13, 13a, 13b, 13c, 13d, 13e, 14, and 15) The electric gripper (72) and gripper fingers (74) of the automated robot (70) are inserted between the centering gates (50) and through a gap (65) that is formed between the centering gates (50) when closed that is wide enough to accommodate the electric gripper (72) and gripper fingers (74). (See FIGS. 10, and 10a) Once the proper torque signal is reached on the electric gripper (72), a signal is sent to a programmable logic controller. A computer interfaces with the programmable logic controller and the robot controller. A DC motor (52) of the media receipt and distribution system (44) then supplies power to the screw and nut system (56) to push the centering gate lever (54) via timing pulleys and a belt (58). (See FIG. 10b) The centering gates (50) then open and the media item is released for the automated robot (70) to remove it from the media receipt and distribution system (44) and to place it in an available slot in the shelving (20) of the housing unit (10). (See FIGS. 1, 3, and 5)

In this alternative embodiment, as further provided in the embodiment previously discussed, illustrated in FIGS. 1, 3, and 5, software in the computer maintains a record of the size and title of each media item. The slots in the shelving (20) of the housing unit (10) are not dedicated. Rather, the software communicates the location of an available slot that will accommodate the media item to the automated robot (70). The automated robot (70) then pivots and inserts the media item into the available slot so that the binding is inserted first to the exterior of the housing unit (10) with the open pages facing toward the automated robot (70). The identification of the media item and its new location are then saved to the computer. By facing the binding outward, identification of the media item can be made by patrons outside of the automated library (1).

To reverse the operation of the system, as illustrated in FIGS. 1, 3, 4, 5, 10, 10a, 10b, 10c, 11, and 12, upon the patron's selection for retrieval of a media item and the subsequent selection of a particular media item via the touch screen (40) of the patron interface panel (36), the automated robot (70) is activated. The robot controller interfaces with a computer. The radio frequency identification scanner incorporated into the automated robot (70) communicates with the computer and the computer communicates with the automated robot (70) which enables the automated robot (70) to locate the selected item via the radio frequency identification scanner and photo eye incorporated into the automated robot (70). The automated robot (70) moves along two linear rails (80, 82) that are affixed to the floor (24) of the housing unit (10) to locate the proper slot in the shelving (20) of the housing unit (10). A servo-motor with brake (78) supplies power to a ball screw (76) which is connected to the automated robot (70). Upon proper identification of the selected media item, a signal is sent to the automated robot (70) to grip the media item via the electric gripper (72) and gripper fingers (74) of the automated robot (70) which provide means for moving the gripper fingers (74) transversely to obtain the item from its slot. (See FIGS. 5, 13, 13a, 13b, 13c, 13d, 13e, 14, and 15. Once the proper torque signal reaches the electric gripper (72), a signal is sent to a programmable logic controller. A computer interfaces with a programmable logic controller and the robot controller. The DC motor (52) of the media receipt and distribution system (44) then supplies power to the screw and nut system (56) to open the centering gate lever (54) via timing pulleys and a belt (58). The centering gates (50) then open and the automated robot (70) places the item within the centering gates (50). The automated robot (70) is then de-activated.

As illustrated in FIGS. 10, 10a, 10b, 11, and 12, the internal door DC motor (98) then supplies power to the two internal door Acme screw and nut systems (102) via the internal door timing pulleys and belt (100). The internal door Acme screw and nut systems (102) are inserted into an internal door Acme screw upper bracket (104). The internal door Acme screw and nut systems (102) are further inserted into an internal door Acme screw lower bracket (106) which is further affixed to the internal door (68) which enables the downward movement of the internal door (68) upon rotation of the internal door Acme screw and nut systems (102), whereby the internal door (68) of the receipt and distribution system (44) closes and locks.

As illustrated in FIGS. 10, 10a, 10b, 11, and 12, the external door DC motor (88) then supplies power to the two external door Acme screw and nut systems (92) via the external door timing pulleys and belt (90). The external door Acme screw and nut systems (92) are inserted into an external door Acme screw upper bracket (94) along with two external door Acme screw support rods (95). The external door Acme screw and nut systems are further inserted into an external door Acme screw lower bracket which is further affixed to the external door (46) which enables the upward movement of the external door (46) upon rotation of the external door Acme screw and nut systems (92), whereby the external door (46) opens.

As illustrated in FIGS. 3, 4, 10, 10a, 10b, 11, and 12, the patron is then notified via the touch screen (40) of the patron interface panel (36) that they may remove the selected media item. Upon removal of the selected media item, the external door DC motor (88) supplies power to the two external door Acme screw and nut systems (92) via the external door timing pulleys and belt (90). The external door Acme screw and nut systems (92) are inserted into an external door Acme screw upper bracket (94) along with two external door Acme screw support rods (95). The external door Acme screw and nut systems are further inserted into an external door Acme screw lower bracket which is further affixed to the external door (46) which enables the downward movement of the external door (46) upon rotation of the external door Acme screw and nut systems (92), whereby the external door (46) closes and locks. The external door Acme screw and nut system (92) will not force the external door (46) to close if an object is blocking the external door (46). Rather, the downward movement will stop and the external door (46) will close via gravity after the object is removed.

The principles, preferred embodiments, and modes of operation in the present invention have been described in the aforementioned specification. The invention, which is intended to be protected herein, is not construed as limited to the particular structures or embodiments disclosed, as these are to be regarded as illustrative rather than restrictive. Variations and changes may be made by those skilled in the art without departing from the invention.

1-20. (canceled)

21. An automated media lending system comprising:
a housing unit comprising a plurality of walls, each of the plurality of walls having an exterior surface and interior surface, at least one of the walls having an interior surface having at least one shelf comprising at least one media slot;
a media receipt and distribution system secured to at least one wall and permitting ingress and egress of media through the housing unit, the media receipt and distribution system comprising a centering gate, an internal door, and an external door;
a programmable robot within the housing; the programmable robot being programmed to retrieve media from the media receipt and distribution system and place such media in a media slot and to retrieve media from a media slot and place such media into the media receipt and distribution system; and
a patron interface panel secured to at least one wall and accessible through the exterior of at least one wall of the housing unit, the patron interface panel comprising at least one of: a touch screen, a keypad, a library card reader, and a receipt printer.

22. The automated media lending system of claim 21, the centering gate comprising two gates wherein each gate is beveled at an angle of at least five degrees.

23. The automated media lending system of claim 22, the two gates having a force applied such that the gates remain in the closed position when no media is present.

24. The automated media lending system of claim 22, the two gates connected to a centering gate shaft that ensures the two gates separate in substantial coordination with each other when media is inserted or removed from the media receipt and distribution system.

25. The automated media lending system of claim 24, the centering gate shaft attached to at least one timing gear, the at least one timing gear attached to the housing unit.

26. The automated media lending system of claim 21, the media receipt and distribution system further comprising a position sensor, the position sensor in coordination with the centering gate confirm proper alignment and position of media in the media receipt and distribution system.

27. The automated media lending system of claim 26, wherein the position sensor is at least one of photo eye and a bar code reader.

28. The automated media lending system of claim 21, the programmable robot comprising a gripper with at least two gripper fingers, the programmable robot programmed to apply torque to the at least two gripper fingers to grip media.

29. The automated media lending system of claim 28, the programmable robot in communication with a computer, the computer programmed to select a media slot in which to store a returned media based on the width of the returned media.

30. The automated media lending system of claim 28, the gripper further comprising a horizontal guide affixed to the bottom of the gripper, the horizontal guide to prevent a gripped media from tipping.

31. The automated media lending system of claim 21, further comprising a computer in communication with the programmable robot, the computer storing information regarding a location of media stored in the at least one media slot.

32. The automated media lending system of claim 31, the computer is programmed to indicate an available media slot for storage of a returned media to the programmable robot upon the insertion of the returned media into the media receipt and distribution system.

33. The automated media lending system of claim 21, the patron interface panel comprising a touch screen in communication with a computer, wherein the computer is programmed to display a list of media contained within the housing unit on the touch screen.

34. The automated media lending system of claim 21, the internal door and the external door connected to at least one electric motor, the at least one electric motor coordinated such that when the external door is an open position the internal door is in a closed position and when the external door is in a closed position the internal door is in an open position.

35. The automated media lending system of claim 34 further comprising a computer in communication with the at least one electric motor and the centering gate, the computer programmed to cause the at least one electric motor to place the external door in the closed position when a returned media is placed in the centering gate.

36. The automated media lending system of claim 35, the computer in further communication with the programmable robot, the computer programmed to cause the programmable robot to retrieve a returned media from the centering gate when the interior door is in the open position.

37. The automated media lending system of claim 21 further comprising a computer in communication with the programmable robot, the media recipient and distribution system further comprising a radio frequency identification scanner and in communication with the computer.

38. The automated media lending system of claim 37, the computer programmed to confirm a media selection based upon a RFID message received from the radio frequency identification scanner.

39. The automated media lending system of claim 21, the housing unit having at least one shelf on the interior surfaces of two walls.

40. The automated media lending system of claim 21, the programmable robot operable to move along at least one linear rail affixed to the housing unit and to pivot about at least one axis.
